(19) United States
(12) Patent Application Publication
(10) Pub. No.: US 2009/0257837 A1
(43) Pub. Date: Oct. 15, 2009

(54) Threading method and threading apparatus

(75) Inventors: Naoki Takahashi, Tochigi (JP); Hiroki Fujiuchi, Tochigi (JP); Yota Eguchi, Tochigi (JP); Yosuke Hiruma, Tochigi (JP)

Correspondence Address: Carrier, Blackman & Associates, P.C., 24101 Novi Road #100, Novi, MI, 48375, US

(73) Assignee: Honda Motor Co., Ltd., Tokyo (JP)

(21) Appl. No.: 12/384,856

(22) Filed: Apr. 9, 2009

(30) Foreign Application Priority Data
Apr. 10, 2008 (JP) 2008-102701

(51) Int. Cl. B23B 35/00; B23B 47/20

(52) U.S. Cl. 408/1 R; 408/14

(57) ABSTRACT

A threading method for threading a work 18 includes a supporting portion moving-up step for moving a supporting portion 17 upward by a predetermined distance by using an elevational mechanism 15 without rotating a tap 20 inserted into the work 18. Thus, the bent state of the robot arm 11 can be eliminated by moving the supporting portion 17 upward. In this case, since the supporting portion 17 is moved upward artificially, the supporting portion 17 can be moved up in a short time. That is, the bent state of the robot arm 11 can be eliminated in a short time and so the processing efficiency of the threading step can be improved.

### BACKGROUND OF THE INVENTION

1. Field of the Invention

The present invention relates to a processing technique for threading a work.

2. Description of Related Art

When forming a female screw at a work, the female screw is sometimes formed by using a threading apparatus. A tap is lowered while being rotated to form the female screw. The tap is rotated reversely and removed from the work after forming the female screw.

When forming a female screw by using a tap, reaction force is imparted to a member for supporting the tap. The member for supporting the tap bends due to the reaction force. Although the bent state disappears when the tap is removed from the work, the complete thread portion of the tap may contact with an inlet portion of the hole of the female screw due to the reaction at the time of the disappearance of the bent state. When the tap contacts with the inlet portion, the tap wears away the inlet portion of the work, so that the external appearance of the inlet portion of a female screw is deteriorated.

An industrial robot is known as an apparatus which can prevent such the contact (see FIG. 1 of Japanese Patent Examined Publication JP-B-3417129, for example).

The JP-B-3417129 will be explained based on the following drawing.

FIG. 11 is a diagram for explaining the basic principle of the JP-B-3417129. An industrial robot 100 has:

an elevational motor 104 which is supported at the tip end of an arm 101 and which rotates a driving gear 102 to rotate a driven gear 103;

a male screw portion 106 which moves in the elevational direction in the drawing in accordance with the rotation of a female screw portion 105 integrally attached to the driven gear 103;

a plate 108 attached to the lower end of the male screw portion 106 and supporting a rotation motor 107; and

a tap 113 which forms a female screw at a work 112 and which is supported by a chuck 111 disposed at the tip end of the shaft 109 of the rotation motor 107.

When forming a female screw at the work 112 by using the industrial robot 100, firstly the elevational motor 104 is operated to rotate the driving gear 102 and the driven gear 103 to thereby lower the male screw portion 106. The male screw portion 106 is lowered until the tip end of the tap 113 contacts with the work 112.

Next, the rotation motor 107 is operated to thereby rotate the shaft 109, the chuck 11 and the tap 113. The tap 113 has a male screw shape. The tap 113 moves downward within the work 112 while forming a female screw within the work 112. In this case, the robot arm 101 bends upward due to reaction force against downward force applied to the work 112 from the tap 113.

When the forming step of the female screw is completed, the locking state of the elevational motor 104 is cancelled. When the locking state of the elevational motor 104 is cancelled, each of the driving gear 102 and the driven gear 103 rotates due to the lowering force of the robot arm 101 and so the robot arm 101 moves downward. That is, the bent sate of the robot arm 101 disappears due to the rotation of the driving gear 102.

After eliminating the bent state in this manner, the tap 113 is rotated reversely and removed from the work 112. Since the bent state of the robot arm 101 is eliminated, the tap 113 is prevented from contacting again with the inlet portion of the hole of the female screw due to the reaction. Further, the tap 113 can be removed without deteriorating the external appearance and the quality of the inlet portion of the female screw.

However, according to the above industrial robot, it is necessary to keep the unlocked state of the elevational motor until the bent state disappears. The efficiency of the operation is deteriorated since it is required to wait until the bent state disappears depending on the force for eliminating the bent state.

### SUMMARY OF THE INVENTION

Accordingly, it is desired to provide a processing technique which can attain the improved efficiency of the operation.

An object of the invention is to provide a processing technique which can process a screw with improved efficiency of the processing.

According to an aspect of the invention, there is provided a threading method for threading by using a threading apparatus which includes:

an elevational mechanism provided at a robot arm;

a rotational mechanism provided at the elevational mechanism so as to be freely movable elevationally;

a tap provided at the rotational mechanism and threading a work in a processing direction; and

a supporting portion provided between the tap and the elevational mechanism and supporting the tap so as to be movable freely with respect to the processing direction,

the method including:

a threading step of inserting the tap into the work while rotating the tap by the rotational mechanism to form a female screw within the work;

a supporting portion moving-up step of moving the supporting portion upward by a predetermined distance by using the elevational mechanism without rotating or elevating the tap inserted into the work; and

a tap removing step of removing the tap from the work while reversely rotating the tap by the rotational mechanism.

Further, according to another aspect of the invention, there is provided a threading apparatus including:

an elevational mechanism provided at a robot arm;

a rotational mechanism provided at the elevational mechanism so as to be freely movable elevationally;

a tap provided at the rotational mechanism and threading a work in a processing direction; and

a supporting portion which is disposed between the tap and the elevational mechanism and which supports the tap freely movable with respect to the processing direction.

Furthermore, according to a still another aspect of the invention, in the threading apparatus, it is adaptable that

the supporting portion is provided at an output end of the rotational mechanism,

the supporting portion supports the tap so as to disable rotation thereof and to be movable elevationally, and

the supporting portion includes:
an upper limit stopper which restricts an upper movable range of the tap; and
a lower limit stopper which restricts a lower movable range of the tap.

According to the aspect of the invention, only the supporting portion is moved upward by the predetermined distance without rotating or elevating the tap. Thus, the bent state of the robot arm can be eliminated by moving the supporting portion upward. In this case, since the supporting portion is forcedly moved upward by the predetermined distance, the supporting portion can be moved upward in a short time. That is, the bent state of the robot arm can be eliminated in a short time and hence the efficiency of the threading step can be improved.

According to another aspect of the invention, the tap is supported so as to be movable freely with respect to the processing direction. Thus, the bent state of the robot arm is eliminated by only moving the supporting portion. Therefore, the tap is prevented from contacting again with the female screw hole by such a simple apparatus.

According to the still another aspect of the invention, the upper limit stopper and the lower limit stopper are disposed. The upper movable range and the lower movable range of the tap are restricted by disposing the stoppers. The tap can receive a force of the elevational mechanisms since the upper limit is defined, and the tap can be firmly supported by the supporting portion in a state that the tap does not contact with a work since the lower limit is defined. Further, the tap can be prevented from being excessively moved upward or downward. In this manner, the tap can be moved elevationally in a suitable range and so the operability of the apparatus can be improved.

### BRIEF DESCRIPTION OF THE DRAWINGS

FIG. 1 is a side view of a threading apparatus according to the invention;

FIG. 2 is a side view of an elevational mechanism and a rotational mechanism according to the invention;

FIG. 3 is an enlarged diagram of a part III of FIG. 2;

FIG. 4 is an enlarged diagram of a part IV of FIG. 2;

FIG. 5 is a diagram for explaining a preparation step according to the invention;

FIG. 6A is a diagram for explaining a threading step according to the invention;

FIG. 6B is an enlarged diagram of a part B of FIG. 6A;

FIG. 7A is a diagram for explaining the upward moving step of a supporting portion according to the invention;

FIG. 7B is an enlarged diagram of a part B of FIG. 7A;

FIG. 8 is a diagram for explaining the removing step of a tap according to the invention;

FIG. 9 is a flowchart for explaining the threading method according to the invention;

FIG. 10 is a diagram for explaining another embodiment different from the embodiment shown in FIG. 2; and

FIG. 11 is a diagram for explaining the basic principle of a related art.

### DETAILED DESCRIPTION OF EXEMPLARY EMBODIMENTS OF THE PRESENT INVENTION

Embodiments of the invention will be explained with reference to attached drawings. Each of the drawings is supposed to be seen according to the direction of symbols.

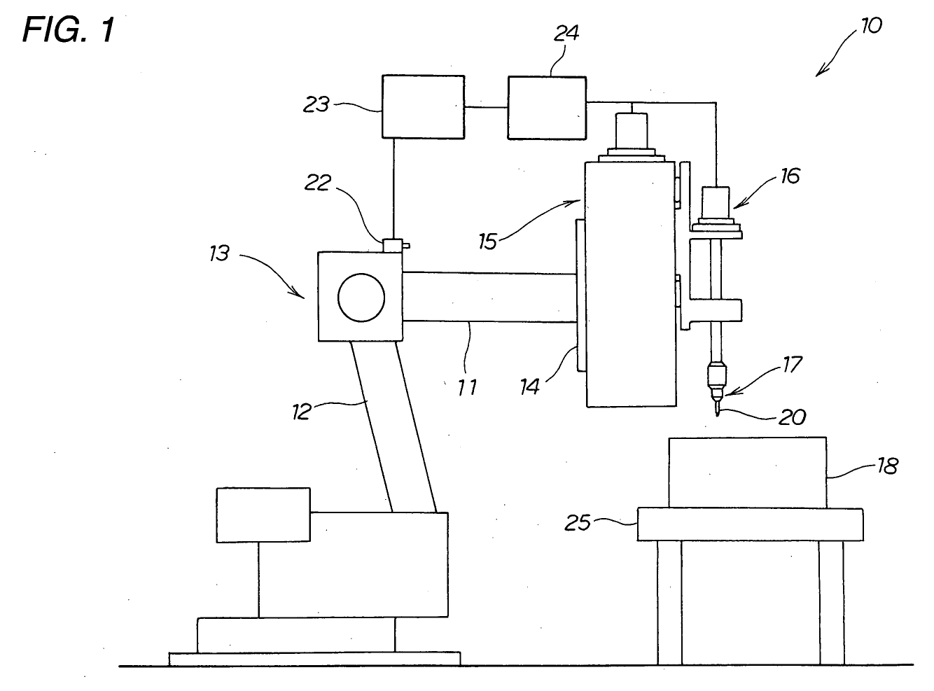

FIG. 1 is a side view showing a threading apparatus 10 according to the invention.

The threading apparatus 10 has:

a robot 13 which has a robot arm 11 disposed at a tip end thereof and operates a positioning arm 12 to determine a threading position for forming a female screw;

an elevational mechanism 15 which is supported via a flange 14 at the tip end of the robot arm 11;

a rotational mechanism 16 which is supported by the elevational mechanism 15;

a supporting portion 17 disposed at the tip end of the rotational mechanism 16;

a tap 20 which is supported by the supporting portion 17 and threads to form a female screw at a work 18;

a sensor 22 which is disposed on the upper surface of the robot 13 and detects the inclination of the robot arm 11;

a calculation unit 23 which calculates information obtained from the sensor 22; and

a control box 24 which operates the elevational mechanism 15 and the rotational mechanism 16 based on information obtained from the calculation unit 23.

The work 18 to be threaded to form a female screw therein is placed on a mount table 25.

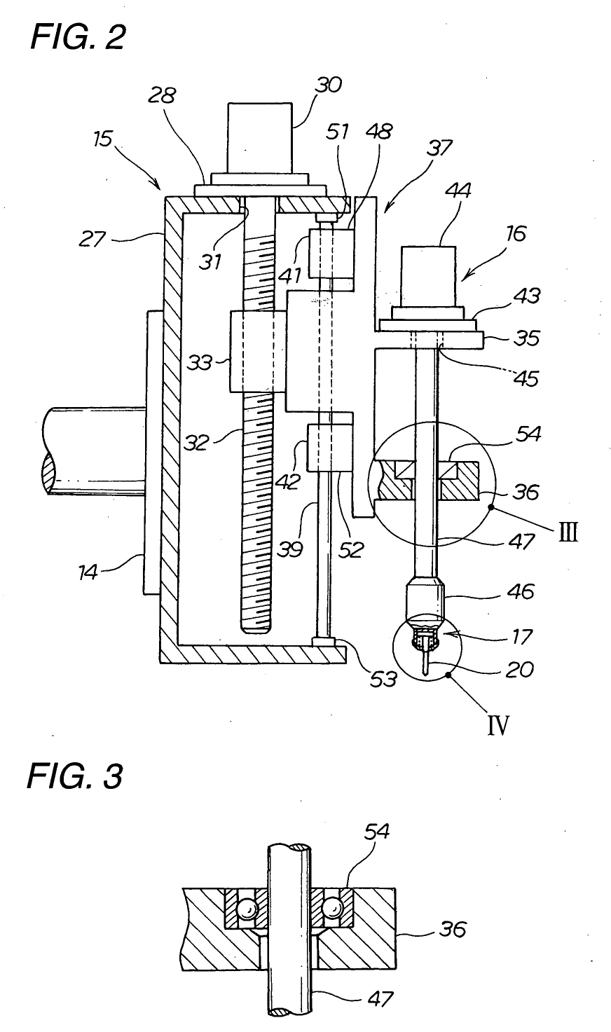

FIG. 2 is a side view showing the elevational mechanism and the rotation mechanism according to the invention.

The elevational mechanism 15 has:

an elevational motor 30 which is supported via a motor flange 28 on the upper surface of a frame 27 attached to the flange 14;

a male screw portion 32 which is extended downward in the figure so as to pass through a hole 31 provided at the upper surface of the frame 27;

a female screw portion 33 which is disposed so as to surround the male screw portion 32 and moves in the elevational direction in the figure in accordance with the rotation of the male screw portion 32;

a portion 37 which supports the rotational mechanism 16 by upper and lower flange portions 35, 36 integrally attached to the female screw portion 33; and

an upper elevational stopper 41 and a lower elevational stopper 42 which are respectively disposed at the upper portion and the lower portion of the supporting member 37 and each moves along a rail 39.

The rotational mechanism 16 has a rotation motor 44 which is supported via a motor flange 43 on the upper surface of a upper flange portion 35, and a shaft 47 which is extended in the downward direction in the figure via a hole 45 shown by a broken line from the rotation motor 44. A chuck 46 is disposed at the tip end of the shaft 47.

When the elevational motor 30 is operated, the male screw portion 32 rotates. When the male screw portion 32 rotates, the female screw portion 33, the supporting member 37, the upper elevational stopper 41, the lower elevational stopper 42, the rotational mechanism 16, the supporting portion 17 and the tap 20 integrally move elevationally.

Each of the female screw portion 33, the supporting member 37, the upper elevational stopper 41, the lower elevational stopper 42, the rotational mechanism 16, the supporting portion 17 and the tap 20 can move from a position where the upper surface 48 of the upper elevational stopper 41 contacts with an upper leg portion 51 of the rail 39 to a position where a lower surface 52 of the lower elevational stopper 42 contacts with a lower leg portion 53 of the rail 39.

That is, the upper limit and the lower limit of the rotational mechanism 16 are defined by the upper elevational stopper 41 and the lower elevational stopper 42, respectively. Since the upper limit and the lower limit are defined, the tap 20 disposed at the tip end of the rotational mechanism 16 is prevented from being moved upward and downward excessively. Thus, the tap 20 can be moved elevationally in a suitable range and so the operability of the apparatus can be improved.

On the other hand, when the rotation motor 44 is operated, the shaft 47, the chuck 46, the supporting portion 17 and the tap 20 are integrally rotated.

FIG. 3 is an enlarged diagram of a part III of FIG. 2, in which the shaft 47 is supported rotatably via a bearing 54 disposed at a lower flange 36. Since the shaft 47 is supported via the bearing 54, the shaft 47 is not wobbling when the shaft 47 rotates.

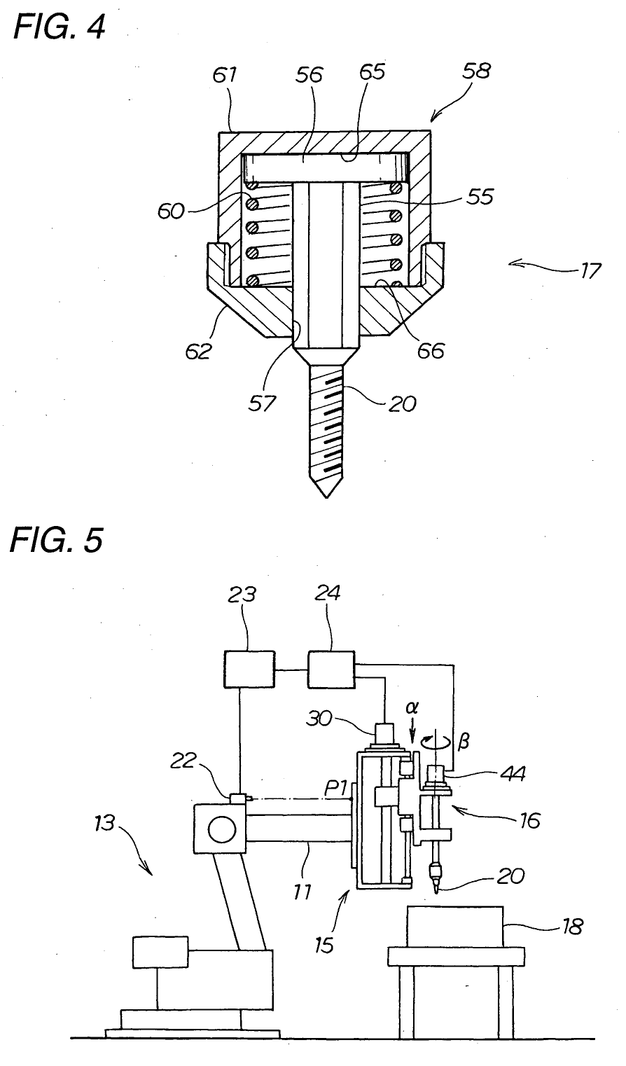

FIG. 4 is an enlarged diagram of a part IV of FIG. 2, in which the tap 20 is supported by a potion 55 of a hexagonal shape. A flange portion 56 is disposed at the top portion of the base portion 55.

The supporting portion 17 has a dividable case 58 which has a hexagonal hole 57 for housing the base portion 55 therein so as to be slidable; and a biasing member 60 such as a compression spring etc. which biases the flange portion 56. The biasing member 60 is housed within the case 58 in the upper direction in the figure.

The flange portion 56, the base portion 55 and the tap 20 are integrally coupled and disposed so as to be movable elevationally in the figure.

In this case, since the hexagonal base potion 55 is fitted into the hexagonal hole 57, there is no fear that the tap 20 may idle.

In addition, a ceiling portion of a case main body 61 acts as an upper limit stopper 65 for restricting the upward movement of the tap 20 and a back surface of a lid 62 acts as a lower limit stopper 66 for restricting the downward movement of the tap 20. Since the stoppers 65, 66 are provided, the upper limit and the lower limit of the tap 20 are defined. The tap 20 can receive a force of the elevational mechanisms 15 since the upper limit is defined, and the tap 20 can be firmly supported by the supporting portion 17 in a state that the tap 20 does not contact with a work 18 since the lower limit is defined. Further, the tap 20 can be prevented from being excessively moved upward or downward. In this manner, the tap 20 can be moved elevationally in a suitable range and so the operability of the apparatus can be improved.

The case 58 has the case main body 61 and the lid 62. After disposing biasing member 60 on the upper surface of the lid 62, the base portion 55 is passed through the hexagonal hole 57, the flange portion 56, the base portion 55 and the tap 20 are disposed, and the case main body 61 and the lid 62 are screwed each other while rotating the case main body 61.

The action of the threading apparatus configured in the aforesaid manner will be explained.

FIG. 5 is a diagram showing a preparation step according to the invention. When a threading position for forming the a female screw hole is determined, the control box 24 operates the elevational motor 30 as shown by an arrow α and simultaneously operates the rotation motor 44 as shown by an arrow β.

In this case, the sensor 22 detects a position P1. That is, the sensor 22 detects position P1 when the robot arm 11 does not bend.

When the elevational motor 30 is continued to be operated in this manner, the tap 20 contacts with the work 18 and starts forming a female screw.

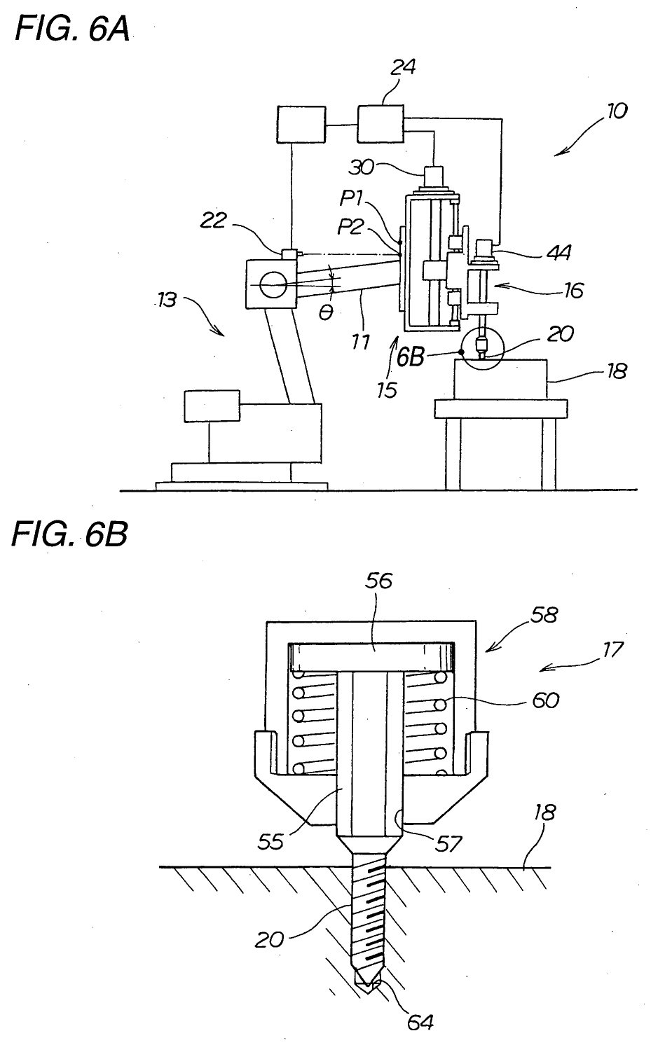

FIGS. 6A and 6B are diagrams for explaining the threading step according to the invention. As shown in FIG. 6A, the control box 24 operates the rotation motor 44 in synchronism with the elevational motor 30 just before the tap 20 contacts with the work 18. Since the tap 20 is rotated by the rotation motor 44, the tap 20 moves downward within the work 18 while threading a female screw.

In this case, the sensor 22 detects a position P2 located beneath the position P1. That is, the robot arm 11 bends by an angle of θ due to reaction force applied from the work 18.

The rotation motor 44 may be operated after the tap 20 contacts with the work 18.

When the threading operation for forming a female screw is performed by rotating the elevational motor 30 and the rotation motor 44 in a synchronous manner, burr generated at the time of forming the female screw can be prevented from scattering out of the work 18.

FIG. 6B is an enlarged diagram of a part B of FIG. 6A. While the tap 20 threads the work 18 so as to form the female screw, the flange portion 56 is placed in a state of contacting with the case 58 due to upward force received from the work 18.

When the forming step of the female screw is completed, the rotation of the tap 20 is stopped for eliminating the bending state of the robot arm 11, as described below.

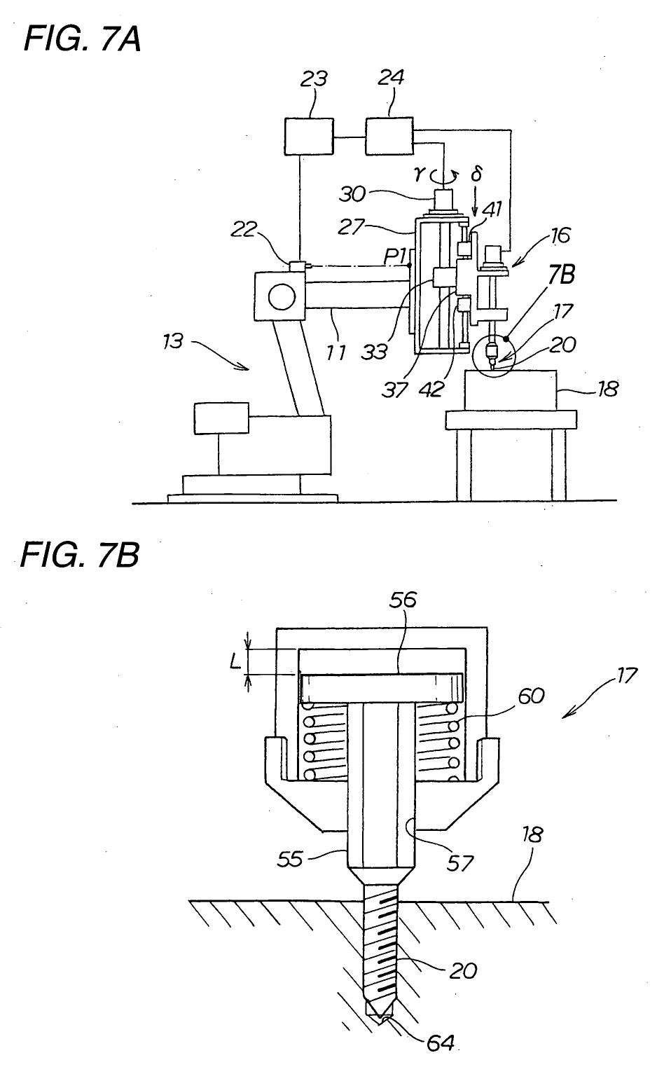

FIGS. 7A and 7B are diagrams for explaining the upward moving step of the supporting portion according to the invention. As shown in FIG. 7A, the control box 24 operates the elevational motor 30 as shown in an arrow γ.

When the elevational motor 30 is operated, each of the female screw portion 33, the supporting member 37, the upper elevational stopper 41, the lower elevational stopper 42, the rotational mechanism 16 and the supporting portion 17 is moved upward. In this case, the tap 20 is kept in a state of being inserted into the work 18.

For moving upward the female screw portion 33, the supporting member 37, the upper elevational stopper 41, the lower elevational stopper 42 and the rotational mechanism 16 while the tap 20 being inserted into the work 18, the supporting member 37 is made slide upward in the figure while remaining the tap 20 in the work 18.

That is, as shown in FIG. 7B, moving upward the supporting portion 17 while remaining the flange portion 56, the base portion 55 and the tap 20, a gap of which length is L is formed between the upper surface of the flange portion 56 and the ceiling surface of the case 58. Then, the bended robot arm 11 tends to restore its original shape and the frame 27, elevational motor 30 and the robot arm 11 are lowered by the length L of the thus formed gap.

Note that based on the information from the sensor 22, the calculation unit 23 determines the length L of the gap so that the bend state of the robot arm 11 is eliminated.

Further, the sensor 22 detects the position P2 when the robot arm 11 is bended, however, the sensor 22 detects the position P1 when the bend state of the robot arm 11 is eliminated. Thus, the elimination of the bending of the robot arm 11 can be detected by the sensor 22 detecting the position P1.

After eliminating the bending of the robot arm 11 as described above, the tap 20 is removed from the work 18.

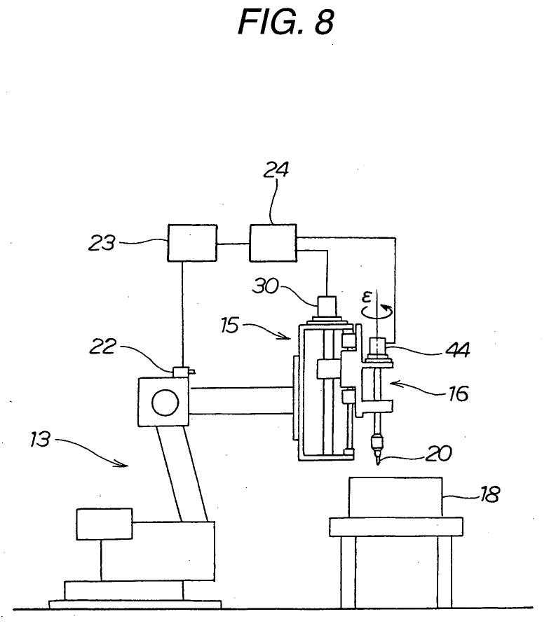

FIG. 8 is a diagram for explaining the removing step of the tap according to the invention. When removing the tap 20, the control box 24 reversely rotates the rotation motor 44 as shown by an arrow ε in synchronism with the elevational motor 30 so as to remove the tap 20 from the work 18. Then, the tap 20 is moved upward, the steps of are completed.

The bent state of the robot arm 11 is eliminated by only moving the supporting portion 17 upward. When the tap 20 is removed from the work 18, the tap 20 is restored to the original position due to the force of the biasing member 60. Thus, the tap 20 is moved upward and is prevented from contacting again with the female screw hole by the simple apparatus.

The threading method as described above will be shown in a flowchart explained below.

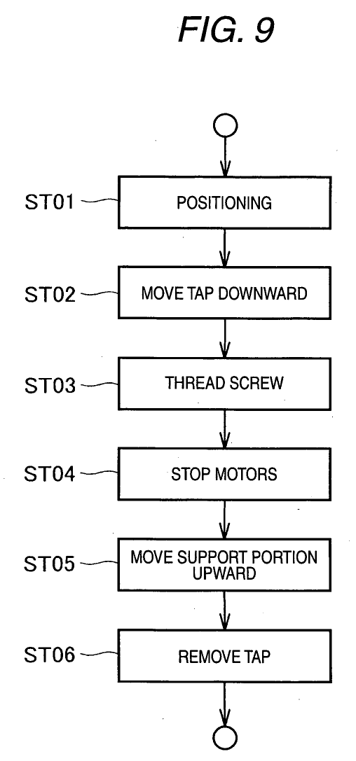

FIG. 9 is a flowchart for explaining the threading method according to the invention. The threading apparatus 10 prepared in a step (hereinafter referred to ST) 01 is operated to move the tap 20 to the threading position for forming the female screw to thereby determining its position.

Next, the elevational motor 30 is operated to thereby move the tap 20 downward to a position just before the tap 20 contacts with the work 18 (ST02). Then, the rotation motor 44 is operated in synchronism with the motor 30 to thereby form the female screw by using the tap 20 (ST03).

When the threading step for forming the female screw is completed, each of the rotation motor 44 and the elevational motor 30 is stopped (ST04). Thereafter, the elevational motor 30 is operated to move the supporting portion 17 upward (ST05). Then, the supporting portion 17 is moved upward to eliminate the bent state of the robot arm 11.

Next, the rotation motor 44 is operated in synchronism with the elevational motor 30 to thereby remove the tap 20 from the work 18 (ST06), whereby the steps are completed.

In this manner, the supporting portion 17 is moved upward by a predetermined distance by using the elevational mechanism 15 without rotating the tap 20. The bent state of the robot arm 11 can be eliminated by moving the supporting portion 17 upward. In this case, since the supporting portion 17 is forcedly moved upward by the predetermined distance, the supporting portion 17 can be moved upward in a short time. That is, the bent state of the robot arm 11 can be eliminated in a short time and hence the efficiency of the threading step can be improved.

Hereinafter, another embodiment of the threading apparatus according to the invention will be explained.

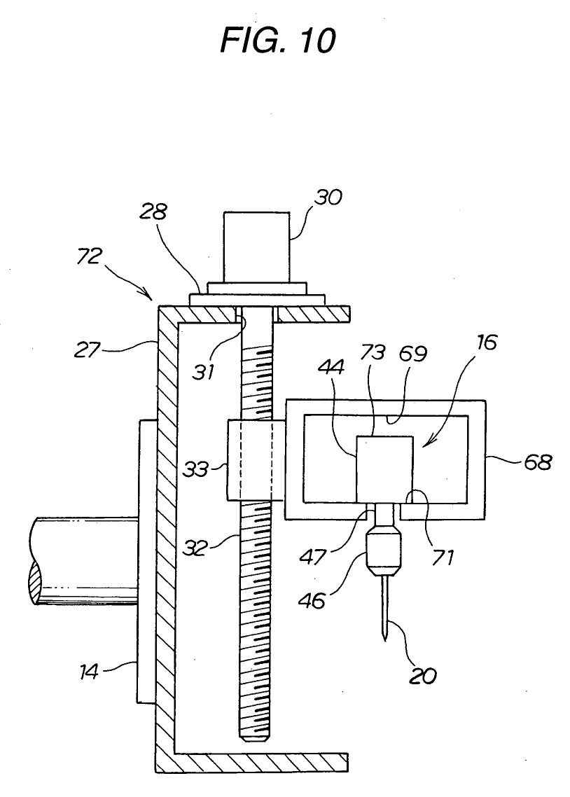

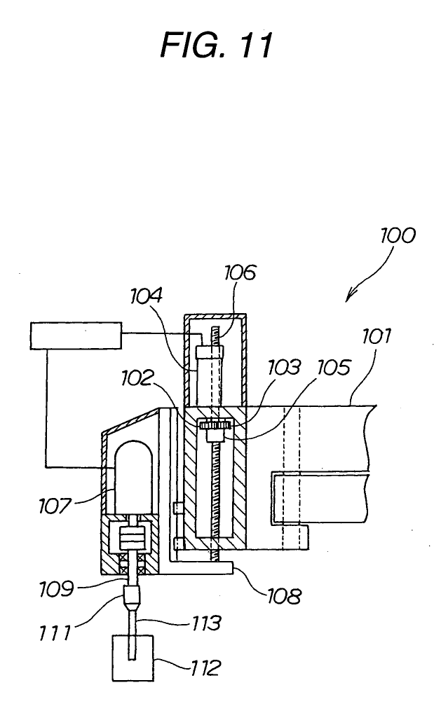

FIG. 10 is a diagram for explaining another embodiment different from the embodiment shown in FIG. 2. In FIG. 10, portions common to those of FIG. 2 are referred to by the same references, with detailed explanation thereof being omitted. In this embodiment, a supporting portion 68 is directly supported by the female screw portion 33.

In this case, a ceiling portion within the supporting portion 68 acts as an upper limit stopper 69 for limiting the upper limit of the tap 20 and a floor portion within the supporting portion 68 acts as a lower limit stopper 71 for limiting the lower limit of the tap 20.

An elevational mechanism 72 has the frame 27, the elevational motor 30, the male screw portion 32 and the female screw portion 33.

In the case where the supporting portion 68 is directly supported by the female screw portion 33, the rotational mechanism 16 elevationally moves within the supporting portion 68 integrally with the tap 20.

That is, in the threading step (FIG. 6), each of the rotational mechanism 16 and the tap 20 is lifted upward by the reaction force of the work 18. The tap 20 threads the work so as to form the female screw in a state that the top portion 73 of the rotation motor 44 contacts with the upper limit stopper 69.

When the threading step is completed, the top portion 73 of the rotation motor 44 is placed in a state of contacting with the upper limit stopper 69. Thus, the bent state of the robot arm 11 can be eliminated by only moving the supporting portion 68 upward in the supporting portion moving-up step.

The tap 20 is supported so as to be movable freely with respect to the processing direction even in the configuration where the supporting portion 68 is directly supported by the female screw portion 33. Since the supporting portion 68 is directly supported by the female screw portion 33, the number of the parts can be reduced and the threading apparatus can be manufactured at a low cost.

It is desirable to dispose a guide member which guides the elevational movement of the rotation motor 44. The guide member can be disposed in a manner that a tube member is provided so as to surround the side surfaces of the motor 16 or a plurality of pillars are provided at the side surfaces of the motor 16.

In addition, when a biasing member (the biasing member 60 of FIG. 4) is disposed within the supporting portion 68 also in another embodiment of the invention, it is possible to absorb a shock if the tap 20 collides with the supporting portion 68.

Although the threading apparatus of the invention is operated by using the control box 24 in the aforesaid embodiments, the threading apparatus may be operated manually in such a case where a bent amount is known empirically in advance based on the combination of the work 18 and the tap 20. That is, the threading apparatus according to the invention can be used irrespective of the manual operation or the automatic operation.

In addition, there arises no problem if the work is heated and softened by using a laser or an arc etc. in advance or a prepared hole is provided at the position where the threading step is performed in order to facilitate the threading step.

The threading apparatus according to the invention is suitable for forming a female screw hole in a work.

What is claimed is:

1. A threading method for threading by using a threading apparatus which comprises:
an elevational mechanism provided at a robot arm;
a rotational mechanism provided at the elevational mechanism so as to be freely movable elevationally;
a tap provided at the rotational mechanism and threading a work in a processing direction; and
a supporting portion provided between the tap and the elevational mechanism and supporting the tap so as to be movable freely with respect to the processing direction,
the method comprising:
a threading step of inserting the tap into the work while rotating the tap by the rotational mechanism to form a female screw within the work;
a supporting portion moving-up step of moving the supporting portion upward by a predetermined distance by using the elevational mechanism without rotating or elevating the tap inserted into the work; and
a tap removing step of removing the tap from the work while reversely rotating the tap by the rotational mechanism.

2. A threading apparatus comprising:
an elevational mechanism provided at a robot arm;
a rotational mechanism provided at the elevational mechanism so as to be freely movable elevationally;
a tap provided at the rotational mechanism and threading a work in a processing direction; and
a supporting portion which is disposed between the tap and the elevational mechanism and which supports the tap freely movable with respect to the processing direction.

3. The threading apparatus according to claim 2, wherein
the supporting portion is provided at an output end of the rotational mechanism,
the supporting portion supports the tap so as to disable rotation thereof and to be movable elevationally, and
the supporting portion comprises:
an upper limit stopper which restricts an upper movable range of the tap; and
a lower limit stopper which restricts a lower movable range of the tap.
